(19) United States
(12) Patent Application Publication
(10) Pub. No.: US 2013/0262201 A1
(43) Pub. Date: Oct. 3, 2013

(54) Gold-Buying Enterprise

(71) Applicant: Brad Bergersen, Severn, MD (US)

(72) Inventor: Brad Bergersen, Severn, MD (US)

(21) Appl. No.: 13/438,004

(22) Filed: Apr. 3, 2012

(51) Int. Cl. G06Q 30/02

(52) U.S. Cl. 705/14.4

(57) ABSTRACT

An improved “gold-buying” marketing endeavor that offers unique services to brick and mortar merchants that allows them to economically qualify a larger percentage of their prospective customers. The improvements to this marketing endeavor include: (1) retail kiosks located on the merchants' sites, (2) software which allows internet-connected computers on these sites to access the webpage and services of a fully-functioning, gold-buying enterprise, (3) advertising materials configured for use by the merchants to advertise that they will buy the gold of their prospective customers at “above-market-rate, offered purchase prices,” (4) a pricing algorithm which shows the merchant how the merchant's profit margin on a specific product will be impacted by the prospective customer applying his/her “above-market-rate, gold-sale proceeds” against the specific product's listed sales price, and (5) a financing algorithm that defines how the marketing endeavor will be is compensated for providing a brick and mortar merchant with these above, market-rate, gold-buying services.

### BACKGROUND OF THE INVENTION

1. Field of the Invention

The present invention relates generally to business finance and marketing services. Specifically, the invention relates to a system for increasing the sales income of a brick and mortar merchant with prospective customers who either do not have, or elect not to use, the cash or credit necessary to purchase the goods of the brick and mortar merchant, but where such prospective customers do have unused gold in the form of jewelry, etc. which could be sold to yield cash to help purchase the goods or services of the brick and mortar merchants.

2. Description of the Related Art

Brick and mortar merchants are continually challenged by having to compete with e-commerce merchants who conduct remote business transactions over the internet and serve large geographic areas in which they have little or no costly capital and manpower investments in storefront, retail or service operations. Thus, such brick and mortar merchants are continually looking for ways to increase their sales volumes and their profitability—including attempting to economically qualify a larger percentage of the prospective customers who take the effort to inquire about the cost of the merchant's goods and ask whether the merchant has any finance programs that would help a prospective customer acquire the merchant's goods.

Meanwhile, there exist many finance-oriented enterprises who seek to help consumers who have limited cash or credit for making desired purchases. Consider, as an example, a typical internet, online gold-purchasing business or enterprise. Such a gold-purchase business usually establishes a website on the internet through which a customer can request an online account. To increase their marketing efforts, these enterprises will often have licensees, who are incentivized entrepreneurs with individual websites setup for them by the enterprise, that effectively offer, under different trade names or brands, the enterprise's basic, gold-purchasing services.

When a customer wishes to sell his or her unused gold or jewelry to the gold-purchase business or its licensee, the customer requests a shipping envelope via an is online account that the customer creates on the enterprise's website. The gold-purchase business then sends a shipping envelope to the customer, having noted the tracking number of the shipping envelope as a transaction ID. The customer then sends the gold-purchase business the gold, typically in the form of unused jewelry, which the customer wishes to sell. The gold-purchase business then determines through standard weighing and assaying techniques the shipped gold's current, potential market value. This is the value that the shipped gold would have for a typical gold bullion merchant after the shipped jewelry or gold has been combined with that of others so as to yield a sufficient quantity to allow it to be refined back into a marketable form for the gold bullion merchant.

For security purposes, the website of a gold-purchase enterprise may offer the customer the opportunity to view a video recording that is made of the actual opening and inventorying of the contents of the customer's shipped envelope. The gold-purchase business, by noting the transaction ID of the received shipping envelope, then updates the associated customer's account with an offered, purchase price for the received gold or jewelry.

The gold-purchase business typically uses a pricing algorithm to set the offered, purchase price. It is usually a fixed percentage of the current, potential market value of the shipped gold, and sufficiently less than the shipped gold's full, current, potential market value so as to allow this difference to cover the enterprise's costs (e.g., for collecting, refining and selling the refined gold to a bullion merchant so that the shipped gold's current, potential market value can actually be realized). If the customer has come to the gold-purchase enterprise's website as a result of the marketing services of a licensee, additional costs could include a possible transaction fee which is paid to any licensee for bringing the customer to the enterprise's website, etc., and possibly a portion of a licensee's upfront licensing fee which the licensee must pay to become the enterprise's licensee.

The gold-purchase business issues a check for the offered price to the customer. If the customer cashes the check, the business transaction is completed. The customer otherwise returns the check and his or her previously shipped gold is is returned to the customer.

However, such gold-purchase enterprises or finance-oriented businesses are currently of little direct help to brick and mortar merchants that need to economically qualify more of their prospective customers. Thus, despite an abundance of internet-based, gold-purchase enterprises, there is a need for systems and methods by which the services of these gold-purchase businesses can be more directly used to aid brick and mortar merchants to increase their sales incomes and profitability.

### SUMMARY OF THE INVENTION

Recognizing the need for the development of improved systems and methods to enable brick and mortar merchants to economically qualify a larger percentage of their prospective customers, the present invention is generally directed to this end.

The present invention relates to an improved marketing endeavor that operates as a licensee of an existing online, gold-purchase or gold-buying enterprise, i.e., the licensor, to increase the enterprise's sales by offering a new group of specialized services to brick and mortar merchants. The improvements to this marketing endeavor include: (1) an interactive kiosk or something similar that is prominently situated in the merchant's retail space and configured to advertise the merchant's unique gold-buying services, (2) an internet-connected computer with specialized software that enables a prospective customer of the brick and mortar merchant to access a webpage which leads the customer through the process of is selling his or her gold, (3) advertising materials configured to advertise that the brick and mortar merchant will buy the gold of their prospective customers at higher than the market-rate, offered purchase prices of other online gold-buying enterprises if their prospective customers will apply their proceeds towards the purchase of the merchant's offerings—products or services, (4) a pricing algorithm which shows the merchant how the merchant's profit margin on a specific product will be impacted by the customer applying his/her “above market-rate, gold-sale proceeds” against the listed sales price of the product or item-for-sale, thereby enabling the merchant to determine if he or she wants to offer the prospective customer an additional sales price discount so as to incentivize the prospective customer to make the purchase, and (5) a financing algorithm by which the brick and mortar merchant acquires this gold-buying capability with zero or near zero capitalization costs by utilizing periodic subscription fees.

Thus, there has been summarized above (rather broadly and understanding that there are other preferred embodiments which have not been summarized above) the present invention in order that the detailed description that follows may be better understood and appreciated.

### BRIEF DESCRIPTION OF THE DRAWINGS

FIG. 1 is an interactive kiosk of the type that would be used by the present invention and located on an operating site of a brick and mortar merchant.

### DESCRIPTION OF THE PREFERRED EMBODIMENT

Before explaining at least one embodiment of the present invention in detail, it is to be understood that the invention is not limited in its application to the details set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention generally relates to an improved method or system for enabling brick and mortar merchants to economically qualify a larger percentage of their prospective customers. As was previously noted, there are many internet-based, online gold-purchasing businesses or enterprises that might be helpful in this regard, but they currently are not.

There are many potential reasons for this situation, including the comparative is high cost that a brick and mortar business would have to pay to get into the gold-purchasing or gold-buying business, where a brick and mortar business must generally become the licensee of a larger, gold-buying enterprise and pay such a licensor a significant upfront licensing fee for this opportunity. Additionally, the fact that many of these new gold-buying businesses are internet-based can be a disadvantage when the situation presents itself that a customer would prefer to have personal dealing with a representative of the actual gold-buying business. Also, some customers may object to the inconvenience and delay created when the online gold-buying business asks them to wait for the delivery to them of a self-addressed return envelope or box and then handle the packaging of the gold which is to-be-sold. Finally, some brick and mortar merchants may not want to take on the task, as a licensee, of providing such additional services for the fear that it will dilute their current efforts on behalf of their current business—wherein these efforts often are already being undertaken with minimal manpower so as to minimize the merchant's operating costs.

Despite these potential barriers for a brick and mortar merchant to utilize gold-buying services to economically qualify a larger percentage of their prospective customers, the nature of the businesses of many brick and mortar merchants seem to give them unique opportunities for utilizing such services if only someone would provide them with less expensive access to such services and show them novel ways to better combine the marketing of their current products with such new product-financing opportunities. For example, merchants of higher priced products that have some flexibility in the profit margins achieved on their individual product sales and who utilize aggressive or significant product marketing programs would appear to have unique opportunities for stimulating sales volumes through the use of specially priced, gold-purchasing services.

An example of such an opportunity is in the used car industry. Used car dealerships can use some of the flexible profit margins that exist in all used car sales to offset the cost that such a merchant would incur if the merchant were to advertise that they had gold-buying services on their premises which would pay those who use them, for example, “TWICE THE OFFERED, PURCHASE PRICE OF is COMPETITIVE GOLD-BUYING SERVICES (if the proceeds from these gold sales were applied towards the purchase of one of the dealership's used cars).”

In an industry where new marketing ideas are always being sought, these unique gold-buying services and their related advertising messages are especially noteworthy, and they do appear to have the ability to both increase the foot traffic through such dealerships while also economically qualifying a larger percentage of such prospective customers.

To consider in more detail how to bring about these new marketing opportunities, recall some of the previously discussed aspects of the typical operation of a marketing endeavor or licensee of a large gold-buying enterprise, i.e., the licensor. These include: (a) a website, usually created with the licensor's input, that is configured with a front-end interface that publicizes and establishes the licensee's gold-buying services (through the resources of the licensor) and allows the licensee's prospective customers to communicate with the licensor's website and server, (b) an inventory of pre-addressed-to-the licensor, sealable shipping containers which include a tracking number, often with the licensee's brand or trademark, for supply to the licensee's customers and to be used by the customer in packing the gold or gold jewelry which the customer wants to sell to the licensee's perceived or the licensor's actual gold-buying service, and (c) customer service facilities that are configured to resolve any problems or answer any questions that a customer encounters or has in selling his or her unused gold to the gold-buying service.

The above-listed aspects or elements of the present, typical licensee can be compared to those of the licensor or actual gold-buying service, which include: (i) a server that includes a processor, memory and a means for connecting to the internet, (ii) software configured to run on the processor and publish a webpage on the internet that includes an interface that publicizes and establishes the gold-buying services of the licensor and allows prospective customers to communicate with the licensor's gold-buying service, (iii) a database configured to store online the account information of prospective customers for use in conducting an online transaction that results in the licensor buying the gold of one of its customers, (iv) a mechanism or means for receiving the sealable shipping container in which a customer will have is placed and sealed unused gold jewelry or gold which the customer desires the licensor to buy, and (v) a video recorder or means for recording the opening of each sealed shipped container and establishing a video inventory of the gold which a customer will have placed in a shipping container.

Further elements or aspects of the licensor's gold-buying service, include: (vi) assaying tools or means that are configured to weigh and assay the video inventoried gold for determining its current, potential market value after the video inventoried gold has been refined back into a marketable form which is acceptable to a gold bullion dealer, (vii) ready access to a refining mechanism or means that is configured to combine gold shipped from a group of customers so as to yield a quantity of gold of a sufficient amount to allow it to be refined back into a marketable form that can be sold to a bullion merchant who will pay the current, potential market value for the combined gold, (viii) a pricing algorithm which the licensor uses to set an offered, purchase price to the customer for the video inventoried gold based upon its assayed current, potential market value, wherein this offered, purchase price is a fixed percentage of the current, potential market value of the gold, and (ix) a contract with the licensee configured so that the licensor receives from the licensee a fee for providing the online, gold-buying services to the licensee's customers, and wherein this fee includes an upfront license fee plus an ongoing transaction fee for every gold-buying transaction that the licensor conducts for each of the customers of the licensee. This transaction fee will often be set as a percentage of the determined current, potential market value of the video-inventoried gold involved in the transaction and wherein this percentage is at least enough to reimburse the licensor for its costs in collecting, refining and selling the refined gold to bullion merchants, plus provide the licensor with an acceptable profit margin.

Returning again to the question of how to bring about the new marketing opportunities envisioned (i.e., buy gold at the sites of brick & mortar merchants at “twice the market rate” to attract customers into these locations and if the customer's proceeds from his/her gold sales are used to buy the merchant's goods or services) by the present invention, listed below are some of the key elements that a participating brick & mortar merchant would need to provide in order to realize these new business is opportunities:

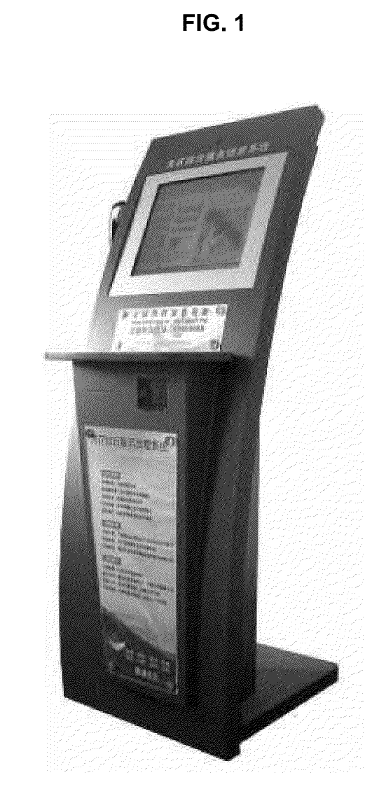

(1) a marketing or retail interactive kiosk or something similar, see FIG. 1, that is prominently situated in the merchant's retail space or on his display floor and configured to advertise the merchant's unique gold-buying services (i.e., paying, e.g., “twice the market rate”),

(2) an internet-connected computer in or near this kiosk that is configured with specialized software or a software program, created by the endeavor which is enabling the merchant to pursue this new opportunity (e.g. a licensee of a fully functioning, online gold-buying enterprise), that enables a prospective customer of the brick and mortar merchant to access a webpage which provides communications between this prospective customer and an online, gold-buying enterprise (e.g., the licensor's),

(3) a video recording, created by the endeavor, that walks a prospective customer through the process of using these new resources on the site of the brick and mortar merchant to sell the prospective customer's gold to the gold-buying enterprise,

(4) advertising materials or means, such as signage at the site of the brick and mortar merchant, printed advertising handouts, printed advertisements placed in newspapers and other print media, configured for use by the brick and mortar merchant to advertise that it will buy the gold of their prospective customers at higher than the market-rate, offered purchase prices of other online gold-buying enterprises if their prospective customers will apply the proceeds (that they receive from any of their gold sales to the licensor's gold-buying enterprise) towards the purchase of the merchant's offerings—products or services,

(5) a pricing algorithm which shows the merchant how the merchant's profit margin on a specific product will be impacted by the customer applying his/her “above market-rate, gold-sale proceeds” against the listed sales price of the product or item-for-sale, thereby enabling the merchant to determine if he or she wants to offer the prospective customer an additional sales price discount so as to incentivize the prospective customer to make the purchase, and

(6) a financing algorithm—the brick and mortar merchant needs to acquire the expertise to implement into his or her current business the above listed new is elements in the most cost-effective manner—i.e., without having to pay the upfront licensing fees which the fully functioning, gold-buying enterprises (licensors) require of their licensees; the present invention makes this possible by utilizing its own unique financing algorithm—e.g., it provides the above listed elements and its expertise on a periodic subscription fee basis, thereby eliminating 100% of the capital cost that the brick and mortar merchant would typically have to incur to order to exploit the unique opportunities disclosed by the present invention (i.e., economically qualify a larger percentage of brick and mortar merchant's prospective customers while utilizing new advertising strategies (i.e., “TWICE THE OFFERED, PURCHASE PRICE OF COMPETITIVE GOLD-BUYING SERVICES) for bringing more prospective customers into their showrooms or retail locations).

For this “improved marketing endeavor” to market its new, expanded services, it would typically prepare and use marketing materials configured to cause brick and mortar merchants to contact the “endeavor” to learn how the endeavor can help such merchants economically qualify a larger percentage of their prospective customers.

The foregoing is considered as illustrative only of the principles of the present invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention that are set forth in the claims to the invention.

For example, the kiosk at the merchant's site need not utilize specialized software that enables a prospective customer of the brick and mortar merchant to access an introductory or intermediate webpage—instead, the kiosk could be to configured so that its internet-connected computer goes directly to the website of the licensor's fully-functioning, gold-buying enterprise. The advantage of this is that the merchant is able to use the good-will that the gold-buying enterprise already has accrued in its good name and its years of offering satisfactory services in this area. However, when the gold-buying enterprise provides its offered, purchase price for the prospective customer's shipped gold, the brick and mortar merchant steps in to confirm that it will top this market-rate price by a significant amount (e.g., twice the offered purchase price) if the prospective customer will apply these proceeds against the purchase of the merchant's goods.

I claim:

1. An improved gold-buying marketing endeavor that allows a brick and mortar merchant to economically qualify a larger percentage of said merchant's prospective customers, the improvements to said marketing endeavor comprising:
a kiosk located on an operating site of said merchant,
a software program which allows an internet-connected computer on said site to access the services of an online, gold-buying enterprise,
an advertising means configured for use by said merchant to advertise that said merchant will pay gold-sale proceeds to their prospective customers which are at above-market-rate, offered purchase prices for said prospective customer's gold that is sold to said online, gold-buying enterprise, and
a pricing algorithm configured to show said merchant how said merchant's profit margin on a specific product will be impacted by said prospective customer is applying said prospective customer's above-market-rate, gold-sale proceeds against said specific product's listed sales price.

2. The improved gold-buying marketing endeavor as recited in claim 1, further comprising:
a financing algorithm that defines how said marketing endeavor will be compensated for providing said brick and mortar merchant with said above-market-rate, gold-buying services.

3. The improved gold-buying marketing endeavor as recited in claim 2, wherein:
said financing algorithm excluding an upfront licensing fee.

4. An improved marketing endeavor, of the type that operates as a licensee of a licensor which is an online, gold-buying enterprise, that allows a brick and mortar merchant to economically qualify a larger percentage of said merchant's prospective customers, the improvements to said marketing endeavor comprising:
a kiosk located on an operating site of said merchant,
a software program which allows an internet-connected computer on said site to access the services of said online, gold-buying enterprise,
an advertising means configured for use by said merchant to advertise that said merchant will pay gold-sale proceeds to their prospective customers which are at above-market-rate, offered purchase prices for said prospective customer's gold that is sold to said online, gold-buying enterprise, and
a pricing algorithm configured to show said merchant how said merchant's profit margin on a specific product will be impacted by said prospective customer applying said prospective customer's above-market-rate, gold-sale proceeds against said specific product's listed sales price.

5. The improved gold-buying marketing endeavor as recited in claim 4, further comprising:
a financing algorithm that defines how said marketing endeavor will be compensated for providing said brick and mortar merchant with said above-market-rate, gold-buying services.

6. The improved gold-buying marketing endeavor as recited in claim 5, is wherein:
said financing algorithm excluding an upfront licensing fee.

7. An improved online, gold-buying enterprise that allows a brick and mortar merchant to economically qualify a larger percentage of said merchant's prospective customers, the improvements to said gold-buying enterprise comprising:
a kiosk located on an operating site of said merchant,
a software program having a configuration which allows an internet-connected computer on said site to access the services of said online, gold-buying enterprise,
an advertising means having a configuration that allows said merchant to advertise that said merchant will pay gold-sale proceeds to their prospective customers which are at above-market-rate, offered purchase prices for said prospective customer's gold that is sold to said online, gold-buying enterprise, and
a pricing algorithm having a configuration that includes an output which informs said merchant how said merchant's profit margin on a specific product will be impacted by said prospective customer applying said prospective customer's above-market-rate, gold-sale proceeds against the potential income from the sale of said specific product at the listed price of said specific product.

8. The improved online, gold-buying enterprise as recited in claim 7, further comprising:
a financing algorithm that defines how said online, gold-buying enterprise will be compensated for providing said brick and mortar merchant with said above-market-rate, gold-buying services.

9. The improved online, gold-buying enterprise as recited in claim 8, wherein:
said financing algorithm excluding an upfront licensing fee.

10. The improved online, gold-buying enterprise as recited in claim 7, further comprising:
a remotely located server that includes a processor, memory and a means for enabling said internet-connected computer to access the services of said online, gold-buying enterprise, and
a database in said memory that is configured to store online the account information of said prospective customer that is for use in conducting an online transaction that results in said enterprise buying the gold of said prospective customers.

11. The improved online, gold-buying enterprise as recited in claim 10, further comprising:
a pre-addressed-to-said-enterprise, sealable shipping container that is supplied to said prospective customers, said container including a tracking number that is associated with said online account information of said prospective customer.

12. The improved online, gold-buying enterprise as recited in claim 11, further comprising:
a means for receiving said sealable shipping container in which said prospective customer will have placed and sealed gold which said prospective customer desires said enterprise to buy, and
an assaying means configured to weigh and assay said sealed gold for determining its current, potential market value after said sealed gold has been refined back into a marketable form for a gold bullion merchant.

13. The improved online, gold-buying enterprise as recited in claim 12, further comprising:
a means for refining said gold that is configured to combine said gold shipped from a plurality of said prospective customers so as to yield a quantity of gold of a sufficient amount to allow said combined gold to be refined back into a marketable form that can be sold to a bullion merchant who will pay the current, potential market value for said combined gold.
